(19) United States
(12) Patent Application Publication
(10) Pub. No.: US 2025/0034025 A1
(43) Pub. Date: Jan. 30, 2025

(54) COUNTER-DIRECTIONAL GAS INJECTION FOR A FURNACE SYSTEM

(71) Applicant: CORNING INCORPORATED, CORNING, NY (US)

(72) Inventors: Julian Lamar Dunn, Winnabow, NC (US); John Michael Jewell, Wilmington, NC (US)

(21) Appl. No.: 18/775,174

(22) Filed: Jul. 17, 2024

Related U.S. Application Data
(60) Provisional application No. 63/529,027, filed on Jul. 26, 2023.

(51) Int. Cl. C03B 37/029; C03B 37/025

(52) U.S. Cl. CPC C03B 37/029; C03B 37/0253; C03B 2205/91

(57) ABSTRACT

Methods, systems, and devices, implementing counter-directional gas injection for a furnace system are described. A furnace system may be configured to heat and draw optically transmissive material to form optical fibers. For example, the furnace system may include an insulated muffle coupled with a heater, where the muffle defines a diametrically consistent cavity in which the optically transmissive material is heated and drawn. The optically transmissive material may be drawn through the cavity in a direction associated with gravity. The furnace system may inject one or more inert gases into the cavity via an inlet port at a bottom portion of the muffle, and release the one or more inert gases from the cavity via an outlet port at a top portion of the muffle, such that the one or more inert gases flow in a direction counter to the drawing of the optically transmissive material.

This application claims the benefit of priority under 35 U.S.C § 120 of U.S. Provisional Application Ser. No. 63/529,027 filed on Jul. 26, 2023, the content of which is relied upon and incorporated herein by reference in its entirety.

### FIELD OF TECHNOLOGY

The present disclosure relates generally to manufacturing optical fibers, and more specifically to counter-directional gas injection for a furnace system.

### BACKGROUND

Optical fibers are key components for transmitting signaling between various electronic devices and components having a wide range of industrial, academic, and commercial applications (e.g., computers, wireless communication networks, media electronic devices such as televisions and stereos, and the like). In some cases, optical fibers may enable data transmissions over a given distance at relatively high data transfer speeds (e.g., compared to other signaling carriers). For example, one or more optical fibers may be implemented in fiber-optic cables spanning relatively large distances and may carry signaling associated with various services, such as media, internet, and phone services, among other examples.

Optical fibers may be manufactured by first heating an optically transmissive material (e.g., optical preforms) until the optically transmissive material reaches a relatively pliable (e.g., malleable, drawable) state. For example, the optically transmissive material may be heated by a furnace component to a temperature associated with a glass softening point, such that the optically transmissive material may be drawn. After heating the optically transmissive material to the relatively pliable state, the optically transmissive material may be drawn (e.g., extruded, extended) to form one or more optical fibers. In some cases, drawing the optically transmissive material may include increasing a length and decreasing a diameter (e.g., a cladding diameter) of the optically transmissive material (e.g., the optically transmissive material forms cylindrical fibrous shapes associated with one or more optical fibers).

### SUMMARY

The described techniques relate to improved methods, systems, devices, and apparatuses that support counter-directional gas injection for a furnace system. Generally, the described techniques provide for injecting one or more inert gases (e.g., one or more inert purge gases) into a cavity of a furnace system, where the cavity is associated with heating and drawing optically transmissive material to form an optical fiber. In some cases, the optically transmissive material may be drawn through the cavity in a draw direction (e.g., a downward direction, a direction associated with gravity), and the one or more inert gases may be injected into a bottom portion of the cavity and released from a top portion of the cavity such that the one or more inert gases flow in an opposite direction (e.g., an upward direction, a direction opposite the first direction) that is counter to the drawing of the optically transmissive material. Using the one or more inert gases within the cavity (e.g., when drawing the optical fiber) may minimize or prohibit the presence of one or more external gases within the cavity when drawing the optically transmissive material, thereby minimizing or precluding unwanted reactions between external gases and one or more materials of the furnace. Further, directing the one or more inert gases through the cavity of the furnace in a direction opposite to the flow of the optically transmissive material may provide a relatively stable convective environment within the cavity, and may enable relatively reduced spatial and temporal variability of purge gas temperature.

A method is described. The method may include injecting one or more inert gases into a cavity defined by a muffle, the muffle comprising an upper muffle extension and a lower muffle extension. In some examples, the one or more inert gases are injected via an inlet port at a bottom portion of the lower muffle extension of the muffle such that the one or more inert gases flow within the cavity in a first direction. The method further comprises drawing optical fiber preform within the cavity in a second direction to form an optical fiber, the first direction being opposite to the second direction. And, the method comprises releasing the one or more inert gases from the cavity via an outlet port at a top portion of the upper muffle extension of the muffle.

A furnace system is described. The furnace system comprising a muffle that defines a cavity, the cavity being configured to receive an optical fiber preform. The furnace system comprising an inlet port disposed at a top portion of the muffle and an outlet port disposed at a bottom portion of the muffle. And the furnace system comprising a heater configured to heat the cavity defined by the muffle. A controller may be coupled with the furnace system and configured to cause the furnace system to inject one or more inert gases into the cavity through the inlet port such that the one or more inert gases flow within the cavity in a direction opposite a draw direction of the optical fiber preform. And, the controller is configured to cause the furnace system to release the one or more inert gases from the cavity via the outlet port.

A furnace system is described. The furnace system comprising a muffle defining a cavity and comprising an insulating material for the cavity. In some examples, the furnace system may include a heater coupled with the muffle and configured to heat the cavity. In some examples, the furnace system may include a downfeed component positioned within the muffle and configured to support an optical fiber preform when the optical fiber preform is extruded from the cavity in a draw direction. In some examples, the furnace system may include an inlet port positioned at a bottom portion of a lower muffle extension of the muffle and configured to inject one or more inert gases into the cavity in a direction that is opposite the draw direction. In some examples, the furnace system may include an outlet port positioned at the upper muffle extension and configured to release the one or more inert gases from the cavity.

### BRIEF DESCRIPTION OF THE DRAWINGS

FIG. 1 shows an example of a furnace system that supports counter-directional gas flow in accordance with aspects of the present disclosure.

FIG. 2A shows an example of a gas injection system that support counter-directional gas flow for a furnace system in accordance with aspects of the present disclosure.

FIG. 2B shows an example of a gas exhaust system that support counter-directional gas flow for a furnace system in accordance with aspects of the present disclosure.

FIGS. 3A and 3B show examples of inlet ports that support counter-directional gas flow for a furnace system in accordance with aspects of the present disclosure.

FIGS. 4A, 4B, and 4C show graphs of diameter control during drawing of an optically transmissive material using furnace systems with and without counter-directional gas flow.

FIG. 5 shows a block diagram of a furnace system that supports counter-directional gas flow in accordance with aspects of the present disclosure.

FIG. 6 shows a flowchart illustrating methods of counter-directional flow in a furnace system in accordance with aspects of the present disclosure.

### DETAILED DESCRIPTION

Optical fibers may be manufactured by heating an optically transmissive material (e.g., a fiber preform material) until the optically transmissive material reaches a relatively pliable (e.g., malleable, drawable) state. For example, the optically transmissive material may be heated by a furnace system to a temperature associated with a softening point such that the optically transmissive material may be drawn. The heated optically transmissive material may then be drawn (e.g., by a component) to form one or more optical fibers. Drawing (e.g., extruding, extending) the optically transmissive material may include increasing a length and decreasing a diameter (e.g., a cladding diameter) of the optically transmissive material (e.g., the optically transmissive material forms cylindrical fibrous structures associated with one or more optical fibers). The optically transmissive material may be cooled during the manufacturing process such that the optically transmissive material exits the relatively pliable state and enters a relatively hardened (e.g., yet flexible) state.

Accordingly, an optical fiber manufacturing system may transport an optically transmissive material through one or more components of the optical fiber manufacturing system. For example, the optical fiber manufacturing system may include at least one or more heating components (e.g., the furnace system, including at least one draw furnace) operable to heat the optically transmissive material, as well as one or more drawing components (e.g., extruder components) operable to draw (e.g., extrude) the optically transmissive material into one or more optical fibers. As such, an optically transmissive material may be heated and drawn to a desired diameter and cooled to a temperature associated with causing the optically transmissive material to exit the relatively pliable state and transition (e.g., associated with a fiber glass transition region) to a relatively hardened state. In some such examples, the optically transmissive material may be heated and drawn in a first direction (e.g., a draw direction that corresponds to extrusion of the optically transmissive material) through a cavity defined by a muffle of the furnace system. For instance, the optically transmissive material may be drawn (e.g., while in the relatively pliable state associated with heating the optically transmissive material) in a downward direction, such that a force of gravity on the optically transmissive material may help to lengthen the optically transmissive material while the optically transmissive material is at an increased temperature.

In some cases, gases may be injected into the cavity to prevent damage to components of the furnace system caused by the presence of other, unwanted gases (e.g., oxygen) in the cavity. For instance, one or more components of the furnace system may include materials (e.g., graphite materials) that may be susceptible to reactions (e.g., oxidation) that cause damage to the components. As an example, the muffle of a furnace system may include one or more graphite materials that, when exposed to oxygen from air, may become oxidized, leading to corrosion and other damage. As such, minimizing the presence of such external gases within the cavity may avoid damage to the furnace system and related components. In some examples, helium may be injected into the cavity due to helium having a relatively high kinematic viscosity and relatively high thermal conductivity, which reduces convective mixing and associated thermal gradients within the purge gas. Helium, however, may be relatively expensive (e.g., helium cost is relatively higher than other non-reactive gasses, which may, for example, be associated with supply constraints and other issues). Further, as helium is a non-renewable resource, the use of helium may be problematic for long-term implementation in optical fiber manufacturing.

Helium may be replaced with one or more other inert gases (e.g., argon, among other examples), but the properties of such other inert gases may be associated with design challenges and lead to other issues with optical fiber manufacturing. For example, while helium may be injected into the cavity of the furnace system in a same direction (e.g., a top-down direction) as the drawing of the optically transmissive material, which may provide a relatively stable convective environment within the cavity due to properties of helium, injecting some other inert gases into the cavity in a similar (e.g., top-down) manner may result in a relatively unstable convective environment within the cavity. This relatively unstable convective environment may result in cooling of the optically transmissive material at an undesired highly variable rate, and properties associated with increased Rayleigh scattering, signal attenuation, and transmission losses, among other disadvantages, may be present in the one or more optical fibers that are subjected to the unstable convective environment during manufacturing. Thus, the one or more other inert gases may not be implemented in the same manner as helium due to differences in properties between helium and the one or more other inert gases (e.g., without substantially changing a design of the furnace system). As a consequence, implementing the one or more other inert gases using the same techniques as with helium may not support efficient control of the diameter of the one or more optical fibers due to convection instability associated with the properties of the one or more other inert gases.

In accordance with examples described herein, a furnace system may implement one or more inert gases (e.g., associated with low thermal conductivity and low momentum) for drawing optically transmissive material such that the one or more inert gases form a relatively stable convective environment within a cavity of the furnace system. Here, the cavity of the furnace system may be defined by a muffle, which may be an insulated hollow chamber region at least partially housing the downfeed component and coupled with the heater. For example, the one or more inert gases may be injected in a direction (e.g., a second direction) that is opposite to the direction in which the optically transmissive material is drawn through the cavity. In particular, the optically transmissive material may be drawn through the cavity in a downward direction (e.g., from the top of the cavity to the bottom of the cavity), and the one or more inert gases may be injected into the cavity via an inlet port at the bottom of the cavity and released from the cavity via an outlet port at the top of the cavity, such that the one or more inert gases may flow counter to the draw direction (e.g., upward) of drawing the optically transmissive material. In some implementations, the inlet port and/or the outlet port may be coupled with a controller (e.g., a mass flow controller) configured to maintain a relatively consistent flow of the one or more inert gases through the cavity. In some aspects, to support the upward flow of the one or more inert gasses within the cavity, the muffle of the furnace system may include an insulated lower muffle, where an inlet port positioned at the bottom of the lower muffle may be used for injecting the one or more inert (purge) gases and enabling the upward flow of such gases. Further, the furnace system may include multiple irises (e.g., positioned below the lower muffle) that may be used to isolate the one or more inert (purge) gases from one or more screen gases.

In some cases, injecting the one or more other inert gases counter to the direction of drawing the optically transmissive material may produce the relatively stable convective environment within the cavity, thereby cooling the optically transmissive material at a relatively slow rate, enabling the manufacture of optical fibers having properties associated with low Rayleigh scattering, signal attenuation, and transmission losses, among other advantages. Furthermore, in some such cases, injecting the one or more other inert gases counter to the direction of drawing the optically transmissive material may support a relatively shorter forming length of the one or more optical fibers, thereby enabling more space for heating, drawing, or cooling the optically transmissive material within the cavity. Moreover, implementing the one or more inert gases counter flowing to the optically transmissive material may benefit from gas properties of the one or more inert gases. For example, the one or more inert gases may be naturally buoyant and thus naturally flow counter to gravity within the chamber, thereby supporting removing one or more flow components from the system that may otherwise be associated with driving a flow of helium (e.g., or one or more other inert gases) through the cavity in the same direction as the optically transmissive material. As a result of the counter flowing one or more inert gases counter to the flow of fiber draw, a quantity of mixed convection drivers may also be reduced, thereby resulting in less spatial and temporal variability in a temperature of the one or more inert gases. In some cases, reducing variability in the convective environment of the optically transmissive material may support improved diameter control of the one or more optical fibers (e.g., compared to other implementations).

Injecting the one or more inert gases using the counter flow relative to drawing the optically transmissive material may prevent external air from entering the cavity. It is noted that external air entering the cavity may result in damage to the muffle and damage to the furnace system. Further, injecting the one or more inert gases counter flow to the optically transmissive material may support replacing helium flowing through the cavity, which may be advantageous. For example, the one or more inert gases may be less expensive than helium, such that replacing helium with the one or more inert gases may result in cost savings during optical fiber manufacturing processes. In some implementations, replacing helium with the one or more inert gases in the manner described herein may reduce manufacturing costs of optical fibers by as much as 5 percent or more. Further, replacing helium with the one or more inert gases may eliminate a risk of helium supply constraints and support more long term sustainability for optical fiber manufacturing, among other advantages.

Aspects of the disclosure are initially described in the context of a furnace system, an inlet port, an outlet port, and graphs that support counter-directional gas injection for a furnace system. Aspects of the disclosure are further illustrated by and described with reference to a block diagram and a flowchart that relate to counter-directional gas injection for a furnace system.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a furnace system 100 to additionally or alternatively solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

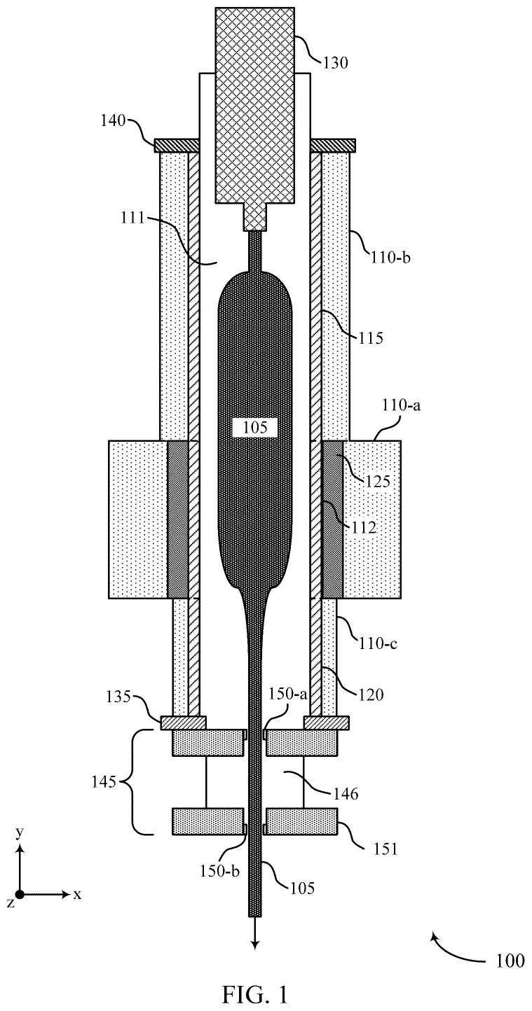

FIG. 1 shows an example of a furnace system 100 that supports counter-directional gas injection for a furnace system in accordance with aspects of the present disclosure. The furnace system 100 may include various optical fiber manufacturing components operable to modify an optically transmissive material 105. For example, the furnace system 100 may include one or more heating components (e.g., a heater 125), a downfeed component 130 (e.g., a downfeed handle), and one or more ports components (e.g., inlet port 135, outlet port 140) configured to modify the optically transmissive material 105. In some cases, one or more inert gases may be injected and released from the furnace system 100 when drawing the optically transmissive material 105, such that the one or more inert gases flow in a direction that is opposite of a direction (e.g., a draw direction) associated with drawing the optically transmissive material 105. In some such cases, implementing the one or more inert gases using the techniques described herein may facilitate a relatively stable convective environment for the optically transmissive material 105, prevent damage to the furnace system 100 by air external to the furnace system 100 entering the furnace system 100, and save costs otherwise associated with implementing other inert gases (e.g., helium), among other advantages.

For illustrative purposes, aspects of the furnace system 100 may be described with reference to an x-direction, a y-direction, and a z-direction of the illustrated coordinate system. For example, FIG. 1 may illustrate a cross-sectional view of the furnace system 100 in an xy-plane, where each of the components may extend for some distance along the z-direction (e.g., into the page, out of the page). In some examples, the y-direction may be referred to as an upward direction and may be illustrative of a direction opposite to a gravitational force. Although the furnace system 100 illustrates examples of relative sizes and quantities of various features, aspects of the furnace system 100 may be implemented with other relative sizes or quantities of such features in accordance with examples as disclosed herein.

In some cases, the furnace system 100 may include a controller (e.g., not shown) configured to control operations of one or more components of the furnace system 100. The controller may include one or more processors operable to perform operations in accordance with configurations, algorithms, or programs stored at the controller or an external memory system. For example, the controller may include a non-transitory computer readable medium configured to store instructions including code operable to cause the controller to perform operations on the furnace system 100.

The optically transmissive material 105 may be an optical fiber preform, such that the optically transmissive material 105 may be manufactured to produce one or more optical fibers. An optical fiber may be a transparent fibrous material configured to transport light or information over a given distance (e.g., a length of the optical fiber). For example, an optical fiber may be configured to carry signaling including a relatively high quantity of information (e.g., data) at a relatively high information transfer speed (e.g., compared to other signaling mediums). Additionally, or alternatively, an optical fiber may be configured to carry light or images (e.g., due to internal light reflection). In some cases, one or more optical fibers may be implemented as a core portion of a fiber-optic cable, and may be surrounded with an insulating material configured to prevent light or information from exiting the fiber-optic cable. Each optical fiber may include a core region surrounded by a transparent cladding material (e.g., a transparent coating). In some examples, the core region may be doped with germania (e.g., germanium dioxide), alkali-doped silica, chlorine-doped silica, or fluorine-doped silica, or any combination thereof. For example, the core region may include alkali-doped silica containing a relatively small quantity of fluorine. In some examples, the optically transmissive material 105 may include a silica glass material, which may further include other materials or dopants. In some examples, a preform (e.g., including the optically transmissive material 105) used for the manufacture of optical fibers may include a consolidated silica glass having one or more concentric regions of the silica glass.

The furnace system 100 may include a muffle 112, which may form a structure for the furnace system 100. The muffle 112 may include a hollow cylindrical structure and one or more portions of the muffle 112 may include a graphite material and/or an insulating material 110-a. In some examples, the insulating material 110-a may include graphite materials. In some examples, the muffle 112 may be configured to maintain elevated temperatures within a cavity 111. The muffle 112 may define the cavity 111 such that an internal region of the muffle 112 forms the cavity 111, and the insulating material 110-a is positioned along (e.g., contacting) the muffle 112 (e.g., to insulate the cavity 111). The muffle 112 may include an upper muffle extension 115 and a lower muffle extension 120 below such that the upper muffle extension 115 is above the lower muffle extension 112 (along the y-direction), where the upper muffle extension 115 and the lower muffle extensions 120 are extended hollow cylindrical structures further defining and forming the cavity 111. In some cases, insulating material may be implemented along the cavity 111 in both the upper muffle extension 115 and the lower muffle extension 120, such that graphite material of the upper muffle extension 115 and the lower muffle extension 120 may be insulated by insulating material 110-b and insulating material 110-c, respectively. For example, the insulating material 110-b is positioned along the upper muffle extension 115, and the insulating material 110-c is positioned along the lower muffle extension 120. The insulating materials 110-b and 110-c may include graphite materials. In some examples, the cavity 111 may have a consistent internal diameter through the length of the muffle 112, in particular through the length of the upper muffle extension 115 and the lower muffle extension 120, such that the cavity 111 may have a same diameter throughout the entirety of the muffle 112.

The muffle 112 may be coupled with one or more heaters 125 such that at least one of the heaters 125 is configured to heat the cavity 111. For example, the heater 125 may be thermally coupled with the muffle 112 and configured to create one or more zones within the cavity 111 with increased heat (e.g., having a temperature between about 1800° C. and about 2100° C.). The one or more zones within the cavity 111 may provide sufficient heat to the cavity 111 to decrease the viscosity of the optically transmissive material 105 (e.g., for drawing the optically transmissive material 105 from a preform into an optical fiber). In some examples, the heater 125 may be configured differently or positioned at other locations than those shown, and various quantities of heaters 125 or heating elements may be possible.

The furnace system 100 may further include a downfeed component 130 (e.g., a downfeed handle) within the cavity 111. For example, the downfeed component 130 may be positioned in a top portion of the cavity 111 associated with the upper muffle extension 115. The downfeed component 130 may be configured to support drawing (e.g., extrusion of) the optically transmissive material 105 from the cavity 111, where drawing the optically transmissive material 105 may include decreasing a width and increasing a length of the optically transmissive material 105.

In some examples, the optically transmissive material 105 may be drawn based on heating the optically transmissive material 105 in the cavity 111 using the heater 125. For example, the heater 125 may heat the optically transmissive material 105 to a temperature equal to or greater than a temperature associated with the optically transmissive material 105 entering a relatively pliable state, at which point the optically transmissive material 105 may be drawn from the cavity 111. In some such examples, the heater 125 and/or the downfeed component 130 may at least partially control a rate or a quantity at which the optically transmissive material 105 is drawn (e.g., based on an operation of the heater 125 and/or the downfeed component 130). In some cases, the downfeed component 130 may be configured to support (e.g., hold) the optically transmissive material 105 (e.g., hold the preform comprising the optically transmissive material 105) as the optically transmissive material 105 is heated for extrusion through the cavity 111 and in a downward direction (along the y-axis), such that a gravitational force acting on the optically transmissive material 105 may draw the optically transmissive material 105 downward (e.g., gravity may pull at the optically transmissive material 105, thereby lengthening and decreasing a width of the optically transmissive material 105). In some such cases, the optically transmissive material 105 may be drawn through the cavity 111 in a same direction as gravity.

The furnace system 100 may include inlet port 135 (e.g., a process gas inlet (PGI)) and outlet port 140 for facilitating a stable convective environment for drawing the optically transmissive material 105. The inlet port 135 may be positioned at a bottom portion of the lower muffle extension 120 and the outlet port 140 may be positioned at a top portion of the upper muffle extension 115. The inlet port 135 and the outlet port 140 may each include one or more channels associated with gas transfer into and out of the furnace system 100, respectively. In some examples, the inlet port 135 may include an annular ring with either a porous metal element or one or more diameter controlled ports (e.g., holes, irises) configured to transfer gas into the cavity 111. The outlet port 140 may include, for example, a channel coupled with a venturi device, a pump, a mass flow controller, or another gas flow release device configured to transfer gas out of the cavity 111.

The inlet port 135 may be configured to inject the one or more inert gases (e.g., gases associated with relatively low thermal conductivity, relatively high buoyancy, low momentum, or any combination thereof) into the cavity 111 and the outlet port 140 may be configured to release the one or more inert gases from the cavity 111. Due to the inlet port 135 being positioned at the bottom portion of the muffle 12 (e.g., bottom portion of the lower muffle extension 120) and the outlet port 140 being positioned at the top portion of the muffle 12 (top portion of the upper muffle extension 115), the one or more inert gases may flow through the cavity 111 in a direction counter to gravity (e.g., along the y-direction). For example, the one or more inert gases may flow through the cavity 111 in the direction counter to the draw direction of the optically transmissive material 105. Further, the one or more inert gases may have a relatively high buoyancy such that the one or more inert gases may naturally rise through the cavity 111 from the inlet port 135 to the outlet port 140. The one or more inert gases flowing through the cavity 111 may form a relatively stable convective environment within the cavity 111, which may at least partially cool the fiber drawn from the optically transmissive material 105. For example, the flow of the one or more inert gases may transition the optically transmissive material 105 from the relatively pliable state to a relatively hardened state, thereby forming one or more optical fibers from the optically transmissive material 105. In some cases, the inlet port 135 and the outlet port 140 may be controlled such that a same or similar flow rate of the one or more inert gases is injected into and released from the furnace system 100, thereby maintaining a consistent flow through the cavity 111.

The furnace system 100 may include a screen region 145 configured to prevent one or more external gases from entering the cavity 111. The screen region 145 may be positioned below the lower muffle extension 120 and may form a second cavity 146, such that the second cavity 146 is downstream of the cavity 111 in the draw direction. In some cases, the optically transmissive material 105 and/or the fiber produced therefrom may be configured to flow through the screen region 145. In some examples, the screen region 145 may include one or more controlled variable openings defining boundaries of the screen region 145. For example, the screen region may include two or more apertures (e.g., irises). The two or more apertures may include a first aperture 150-a, which may be positioned at a top portion of the screen region 145, and a second aperture 150-b, which may be positioned at a bottom portion of the screen region 145. In some examples, each of the apertures 150-a and 150-b may have a thickness along the y-direction less than about 1 mm, or less than about 0.75 mm, or less than about 0.50 mm, or less than about 0.25 mm. The apertures 150-a and 150-b may each be configured to selectively open and close such that, when the optically transmissive material 105 is not being drawn, the apertures 150-a and 150-b may close, but when the optically transmissive material 105 is being drawn, the apertures 150-a and 150-b may at least partially open to enable the extrusion of the optically transmissive material 105 (and/or the optical fiber formed therefrom) for forming the optical fibers. For example, as and discussed below, the apertures 150-a and 150-b may each include an expandable or collapsible manifold (e.g., a circular port with a variable diameter) configured to open to some diameter (e.g., 2 inches) and close to a partially closed diameter (e.g., ranging between 0.125 inches and 0.25 inches) or a fully closed position (e.g., sealed, fully closed). In some cases, the apertures may be configured to close or open to an extent defined by the diameter of the resulting optical fiber, to prevent one or more external gases from entering the cavity 111 while drawing the optically transmissive material 105.

In some cases, a screen gas may be injected into the second cavity 146 via a port 151, which may be positioned near the aperture 150-a or the aperture 150-b, to prevent the one or more external gases from entering the second cavity 146 (e.g., to prevent the external gases from entering the second cavity 146 via a gap between the optically transmissive material 105 and the aperture 150-b) or from entering the cavity 111 (e.g., to prevent the external gases from entering the cavity 111 via a gap between the optically transmissive material 105 and the aperture 150-a). The screen gas in the second cavity 146 may also prevent the one or more inert gases in cavity 111 from exiting the cavity 111 (e.g., exiting the cavity 111 via a gap between the optically transmissive material 105 and the aperture 150-a). In some such examples, the apertures 150-a and 150-b may be configured to close such that the screen region 145 is sealed (e.g., hermetically sealed) such that the one or more external gases may not enter the screen region 145 when the apertures 150-a and 150-b are closed. In some examples, the apertures 150-a and 150-b may be configured to close such that the screen gas within the second cavity 146 forms a pressure differential between the second cavity 146 and the one or more external gases, thus preventing the one or more external gases from entering the screen region 145.

In accordance with examples as described herein, implementing the one or more inert gases that flow in a direction that is opposite a draw direction for extruding the optically transmissive material 105 may support improved diameter control of one or more resulting optical fibers. Additionally, the one or more inert gases flowing through the cavity 111 may prevent external air from entering the cavity 111, which may otherwise damage the muffle 112 and/or insulating material (e.g., the insulating material 110-a, 110-b, and/or 110-c), for example, due to oxidization of graphite material through exposure to external air (particularly at increased temperatures). Further, the one or more inert gases may be associated with cost efficiency compared to previous implementations (e.g., using helium in a top-down flow). In some cases, implementing the one or more inert gases may not include substantially changing the furnace system 100, such that legacy furnace systems may implement the techniques described herein.

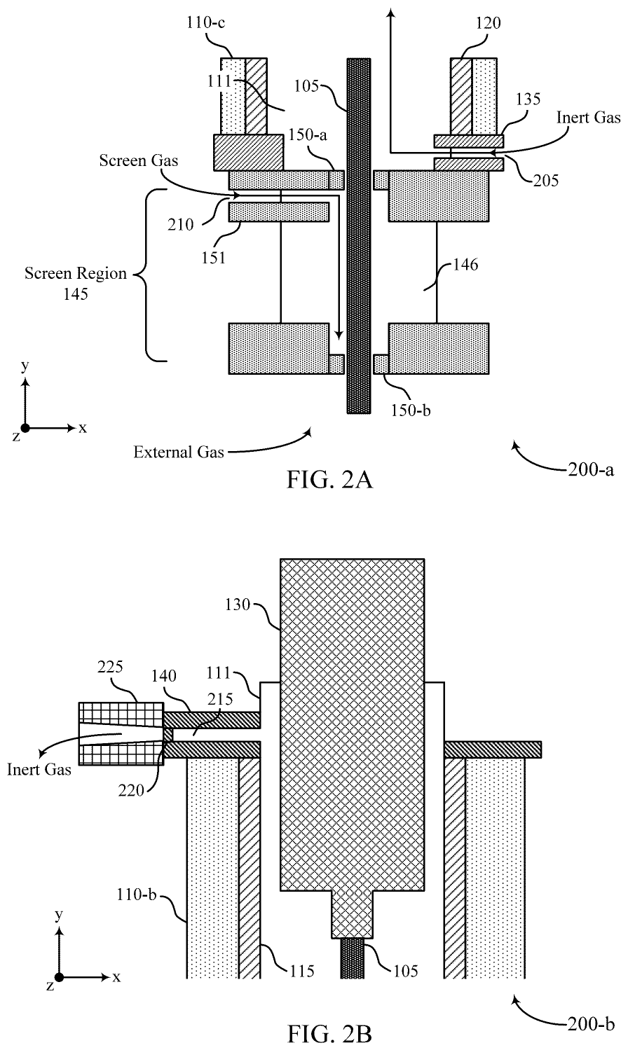

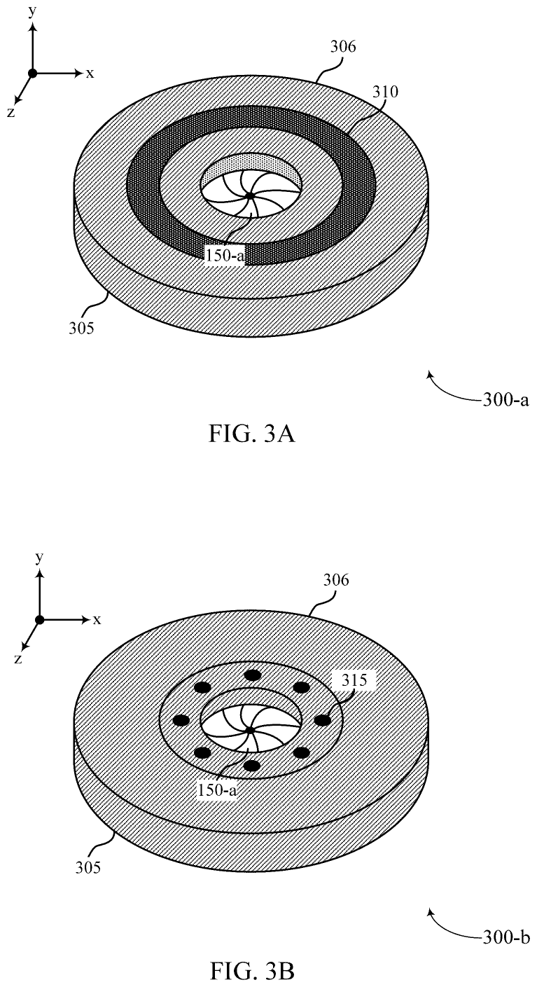

FIGS. 2A and 2B show examples of a gas injection system 200-a and a gas exhaust system 200-b, respectively, that support counter-directional gas injection for a furnace system in accordance with aspects of the present disclosure. The gas injection system 200-a and the gas exhaust system 200-b may be examples of or implement aspects or operations of a furnace system 100, as described with reference to FIG. 1. For example, the gas injection system 200-a and the gas exhaust system 200-b may be implemented at the furnace system 100 and may include inlet port 135 and outlet port 140, respectively, among other components of the furnace system 100.

For illustrative purposes, aspects of the gas injection system 200-a and the gas exhaust system 200-b may be described with reference to an x-direction, a y-direction, and a z-direction of the illustrated coordinate systems. For example, FIGS. 2A and 2B may illustrate a cross-sectional view of the gas injection system 200-a and the gas exhaust system 200-b, respectively, in an xy-plane, where each of the components may extend for some distance along the z-direction (e.g., into the page). In some examples, the y-direction may be illustrative of a direction opposite to gravitational force. Although the gas injection system 200-a and the gas exhaust system 200-b illustrates examples of relative sizes and quantities of various features, aspects of the gas injection system 200-a and the gas exhaust system 200-b may be implemented with other relative sizes or quantities of such features in accordance with examples as disclosed herein.

The gas injection system 200-a may include inlet port 135 (e.g., a process gas inlet (PGI)), as discussed above, which may be configured to inject one or more inert gases (e.g., associated with relatively low thermal conductivity, relatively high buoyancy, low momentum, or any combination thereof) into a cavity 111 (e.g., to facilitate cooling of an optically transmissive material 105). The inlet port 135 may be positioned at a bottom portion of a lower muffle extension 120 defining the cavity 111. In some cases, the inlet port 135 may at least partially surround the cavity 111 or be at least partially surrounded by the cavity 111. In some such cases, the inlet port 135 may be one of one or more inlet ports 135. The inlet port 135 may include one or more channels 205 associated with gas transfer into the cavity 111. In some examples, the inlet port 135 may include an annular ring with either a porous element or one or more ports (e.g., holes, irises) configured to transfer the inert gas into the cavity 111. The inlet port 135 may form a plenum within the cavity 111 and/or the second cavity 146. In some implementations, the inlet port 135 may be configured to transfer the one or more inert gases into the cavity 111 at a flow rate ranging between about 10 and about 20 liters per minute.

The gas injection system 200-a may include screen region 145, as discussed above, configured to prevent one or more external gases from entering the cavity 111. The screen region 145 may be positioned below the lower muffle extension 120 (e.g., below the inlet port 135, along the y-direction). The screen region 145 may form second cavity 146, as discussed above, through which the optically transmissive material 105 and/or the fiber produced therefrom may flow. In some cases, a screen gas may be injected into the second cavity 146 via one or more ports 151. Additionally, the gas injection system 200-a may include the apertures 150-a and 150-b, as discussed above.

The gas exhaust system 200-b, as shown in FIG. 2B, may include outlet port 140, as discussed above, which may be configured to release the one or more inert gases from the cavity 111. The outlet port 140 may be positioned at a top portion of upper muffle extension 115. In some cases, the outlet port 140 may at least partially surround the cavity 111. In some cases, the outlet port 140 may comprise one of one or more outlet ports 140. The outlet port 140 may include one or more channels 215 associated with gas transfer out of the cavity 111. In some examples, the outlet port 140 may include an aperture 220 (e.g., iris) coupled with each channel 215 and configured to transfer gas out of the cavity 111 via a channel 215. In some examples, the aperture 220 may be coupled with an exhaust device configured to control the gas pressure inside the cavity 111 and control transferring the gas out of the cavity 111. For example, an exhaust device 225 may be an example of a pump, a mass flow controller, or another gas flow release device configured to transfer gas out of the cavity 111. In some embodiments, the exhaust device 225 is a venturi device configured to release gas from the cavity 111. In some implementations, the outlet port 140 may be configured to transfer the one or more inert gases out of the cavity 111 at a flow rate ranging between about 10 and about 20 liters per minute. In some such implementations, the flow rate of the inlet port 135 may be approximately equivalent to the flow rate of the outlet port 140 to facilitate relatively consistent flow of the one or more inert gases within the cavity 111. In some examples, the flow rate of the inlet port 135 and the outlet port 140 are both between about 10 and about 20 liters per minute. In some aspects, the flow rate of the inlet port 135 or the outlet port 140, or both, may be controlled by a controller coupled to the gas injection system 200-a and the gas exhaust system 200-b.

In some cases, the one or more ports 151 may be configured to transfer the screen gas into the second cavity 146 at a flow rate that is approximately equivalent to the flow rate of the inlet port 135 and/or the outlet port 140. In some embodiments, the one or more ports 151 transfer the screen gas into the second cavity 136 at a flow rate between about 10 and about 20 liters per minute, or less than about 20 liters per minute, or less than about 15 liters per minute. The screen gas may flow in a downward direction and out through an opening between the optically transmissive material 105 (or the optical fiber produced therefrom) and the aperture 150-b such that the external gases are prevented from entering the cavity 111, or such that any external gases that do enter the cavity 111 is minimized.

In accordance with examples as described herein, implementing the gas injection system 200-a and the gas exhaust system 200-b to facilitate transferring the one or more inert gases through the cavity 111 may produce a relatively stable convective environment within the cavity 111, thereby supporting improved drawing (e.g., and cooling) of the optically transmissive material 105. In some cases, ensuring counter flow of the one or more inert gases may support improved diameter control of one or more resulting optical fibers. Additionally, the one or more inert gases flowing through the cavity 111 may prevent external air from entering the cavity 111, which may otherwise damage the furnace system 100. Further, the one or more inert gases may be associated with cost efficiency compared to previous implementations (e.g., using helium in a top-down flow). In some cases, implementing the one or more inert gases may not include substantially changing the furnace system 100, such that legacy furnace systems may implement the techniques described herein.

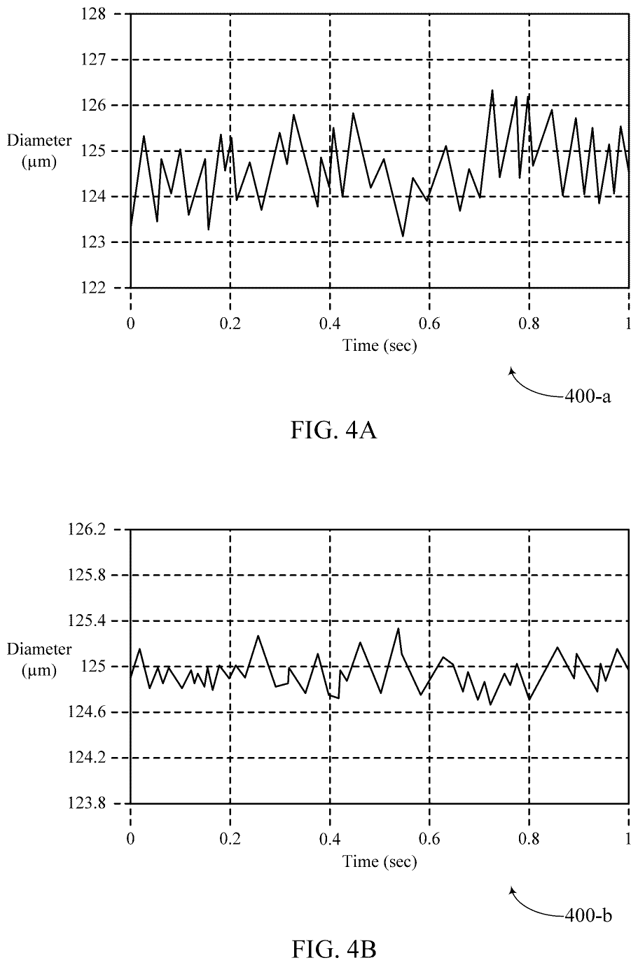

FIGS. 3A and 3B show examples of an inlet port 300-a and an inlet port 300-b that support counter-directional gas injection for a furnace system in accordance with aspects of the present disclosure. The inlet port 300-a and 300-b are each separate examples of or implement aspects or operations of inlet port 135, as discussed above with reference to FIGS. 1 and 2A. Although the inlet port 300-a and 300-b each illustrate examples of relative sizes and quantities of various features, aspects of the inlet port 300-a and 300-b may be implemented with other relative sizes or quantities of such features in accordance with examples as disclosed herein. FIG. 3A further shows the inlet port 300-a in association with and coupled to the first aperture 150-a, and FIG. 3B similarly shows the inlet port 300-b in association with and coupled to the first aperture 150-a.

The inlet port 300-a may be configured to provide a port through which one or more inert gases may be injected into the cavity 111, which may extend in the y-direction from a top surface of the inlet port 300-a. For example, the inlet port 300-a may at least partially surround the cavity 111. In some cases, the inlet port 300-a may be concentric with the cavity 111. In some examples, the inlet port 300-a may be implemented below the cavity 111. The inlet port 300-a may include a porous ring 310 (which may function as a manifold for transferring gas into the cavity 111) that may include a quantity of relatively small channels through which the one or more inert gases may be injected into the cavity 111. In some embodiments, porous ring 310 is comprised of metal. The porous ring 310 may be configured to provide a pressure drop such that a flow velocity coming through the porous ring 310 is approximately azimuthally uniform. For example, one or more inert gases may be transferred through small channels of the porous ring 310 and into the cavity 111. The porous ring 310 may control a flow rate of the one or more inert gas injected into the cavity 111. In some examples, the one or more inert gases may be injected into the cavity 111 in an upward direction through the porous ring 310 (e.g., such that the inlet port 300-a is mounted below the cavity 111) to facilitate the flow of the one or more inert gases upwards within the cavity 111. The inlet port 300-a may also include an annular ring 305, which may be an annular plenum ring and may be comprised of a graphite or metal material. The annular ring 305 may be concentric with the cavity 111 and the porous ring 310, and at least partially surround the porous ring 310 in a radial direction. In some examples, the annular ring 305 and/or the porous ring 310 may be coupled with a controller (e.g., a mass flow controller), where the controller is configured to control a rate at which the one or more inert gases are injected via the porous ring 310.

Similarly, the inlet port 300-b may be configured to provide a port through which the one or more inert gases may be injected into the cavity 111. For example, the inlet port 300-b may at least partially surround the cavity 111. In some cases, the inlet port 300-b may be concentric with the cavity 111. The inlet port 300-b may include a quantity of ports 315 (e.g., holes functioning as a manifold for transferring gas into the cavity) which may each include a relatively small channel through which the one or more inert gases may be injected into the cavity 111. In some embodiments, the ports 315 are circular in cross-section. In some aspects, a volume and/or a velocity of the one or more inert gasses flowing through each of the ports 315 may be approximately the same. For example, one or more inert gases may be transferred through channels of the ports 315 and into the cavity 111. The ports 315 may control a flow rate of the one or more inert gas injected into the cavity 111. For example, the ports 315 may each comprise a controlled variable opening configured to open and close (e.g., an iris, an expandable and collapsible opening) that may have a controllable diameter such that a flow rate of the one or more inert gases may be controlled based on modifying the diameter size. In some examples, the one or more inert gases may be injected into the cavity 111 in an upward direction through the ports 315 to facilitate the flow of the one or more inert gases upwards within the cavity. In some implementations, the ports 315 may be positioned along a circle and may be equidistant from a center of the cavity 111. The inlet port 300-b may also include an annular ring 305, which may be an annular plenum ring and may be comprised of a graphite or metal material. The annular ring 305 may be concentric with the cavity 111 and with the quantity of ports 315, and at least partially surround the quantity of ports 315 in a radial direction. In some examples, the annular ring 305 and/or the ports 315 may be coupled with a controller (e.g., a mass flow controller), where the controller is configured to control a rate at which the one or more inert gases are injected via the ports 315.

The inlet port 300-a and the inlet port 300-b may be understood to be non-limiting examples of inlet port 135. However, the inlet port 135 may comprise other alternatives not described herein. For example, the inlet port 135 may include one relatively large circular port surrounding the cavity 111, among other possibilities. That is, the porous ring 310 and the quantity of ports 315 may not be the only components for injecting the one or more inert gases into the cavity 111. In some cases, the inlet port 300-a and the inlet port 300-b may provide similar advantages for providing a stable convective environment for drawing an optically transmissive material, such that variations in performance between the porous ring 310 and the ports 315 for injecting the one or more inert gases into the cavity may be negligible.

Additionally, FIGS. 3A and 3B each depict the first aperture 150-a in association with the inlet port 300-a, 300-b, respectively. As discussed above, the first aperture 150-a may be configured to prevent one or more external gases from entering the cavity 111. In some cases, the first aperture 150-a may be configured to form a seal when the optically transmissive material 105 is not being drawn. Furthermore, the aperture 150-a may be configured to open to an extent defined by the diameter of the optically transmissive material 105 during drawing. Additionally, the first aperture 150-a may be configured to prevent the screen gas from entering into the cavity 111. In some cases, as shown in FIGS. 3A and 3B, the first aperture 150-a may include a circular manifold with a selective diameter, such that the circular manifold opens and closes to modify the size of the opening formed by the aperture 150-a, thus changing the diameter of the opening. Therefore, first aperture 150-a may comprise an opening with a variable diameter. In some embodiments, first aperture 150-a is configured to open to a fully open diameter of about 2 inches, to partially close to a partially closed diameter ranging from about 0.125 inches to about 0.25 inches, and to fully close to fully closed position that forms a seal. It is noted that the partially closed position may open wide enough to allow the optically transmissive material (or the fiber drawn therefrom) to pass through the opening of the first aperture 150-a.

However the first aperture 150-a may be implemented with a different shape, other than shown in FIGS. 3A and 3B, configured to perform the same function. The first aperture 150-a may be disposed radially interior to the annular ring 305 and the porous ring 310 or the ports 315. In some examples, the first aperture 150-a may be flush with and disposed along the same plane as a top surface 306 of the annular ring 305. However, in other examples, the first aperture 150-a may be at least partially below the top surface 306 of the annular ring 305 (e.g., inlayed such that the top surface 306 is closer to the upper muffle extension 115 than the aperture 150-a).

It is also noted that second aperture 150-b may comprise the same design and function as that depicted of first aperture 150-a in FIGS. 3A and 3B. Therefore, second aperture 150-b may also comprise a circular manifold with a selective diameter, such that the circular manifold opens and closes to modify the size of the opening formed by the second aperture 150-b, thus changing the diameter of the opening. Similar to first aperture 150-a, second aperture 150-b may also be configured to form a seal when the optically transmissive material 105 is not being drawn, and the second aperture 150-b may be configured to open to an extent defined by the diameter of the optically transmissive material 105 (or the fiber formed therefrom) during drawing.

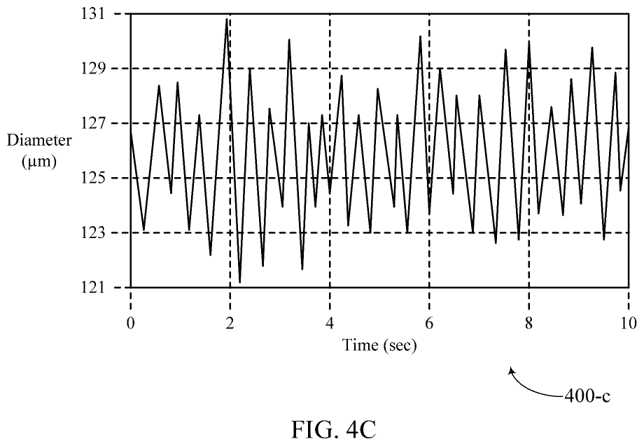

FIGS. 4A, 4B, and 4C show graphs 400-a, 400-b, and 400-c of counter-directional and co-directional gas flow for furnace systems. The graphs 400-a, 400-b, and 400-c each depict an outer diameter (e.g., an outer cladding diameter) of optically transmissive material 105 as the optically transmissive material 105 is drawn through a cavity of the furnace system over time. The graphs 400-a, 400-b, and 400-c illustrate differences in diameter control during drawing of the optically transmissive material 105.

More specifically, graph 400-a illustrates the outer diameter of the optically transmissive material 105 while drawing the optically transmissive material 105 within cavity 111 using furnace system 100 but wherein the lower muffle extension 120 is not insulated (such that furnace system 100 does not include insulating material 110-c surrounding the cavity 111) and wherein the inert gases flow within cavity 111 in a direction opposite to the drawing direction of the optically transmissive material 105. Graph 400-b illustrates the outer diameter of the optically transmissive material 105 while drawing the optically transmissive material 105 within cavity 111 using furnace system 100 wherein the lower muffle extension 120 is insulated (such that furnace system 100 includes the insulating material 110-c) and wherein the inert gases flow within cavity 111 in a direction opposite to the drawing direction of the optically transmissive material 105. Graph 400-c illustrates the outer diameter of the optically transmissive material 105 while drawing the optically transmissive material 105 using furnace system with a co-directional gas flow. More specifically, in the furnace of graph 400-c, the inert gases flow within a cavity of the furnace in the same direction as the drawing direction of the optically transmissive material 105. Therefore, the inert gases are injected into the cavity at a top portion of the cavity and released from the cavity at a bottom portion of the cavity. Furthermore, the furnace of graph 400-c comprises the insulating material 110-c.

A comparison of graphs 400-a and 400-b show that insulation in the lower muffle extension 120 produces relatively more diameter control of the optically transmissive material 105. That is, graph 400-a, which has no insulation in the lower muffle extension 120, has more variability in the diameter of the optically transmissive material 105 during drawing than graph 400-b, which has insulation in the lower muffle extension 120. Insulating the lower muffle extension 120 (and other components of muffle 112) may create a monotonic temperature gradient sidewall along the cavity 111, thereby producing a stable convective environment within the cavity 111 and, thus, increasing diameter control of the optically transmissive material 105 within the cavity 111. Conversely, the lack of insulation along lower muffle extension 120 may produce a mixed, relatively unstable convective environment within the cavity 111, which may decrease diameter control of the optically transmissive material 105 within the cavity 111. In some cases, insulating the lower muffle extension 120 may shorten a forming length of the optical fibers, thereby enabling relatively higher speed for forming the optical fibers within a same volume or vertical space of the cavity 111.

A comparison of graphs 400-a and 400-b with graph 400-c shows that implementing the counter-directional gas flow produces more diameter control of the optically transmissive material 105. That is, injecting the one or more gases into the upper muffle extension 115 and releasing the one or more gases from the lower muffle extension 120 (graph 400-c) produces more variability in the diameter of the optically transmissive material 105 during drawing of the optically transmissive material 105 as compared with injecting the one or more inert gases into the lower muffle extension and releasing the one or more gases from the upper muffle extension (graphs 400-a and 400-b). Further, the co-directional gas flow of graph 400-c, as described with reference to FIG. 4C, may produce a mixed, relatively unstable convective environment within the cavity 111, which may decrease diameter control of the optically transmissive material 105 within the cavity 111. In some cases, the counter-directional gas flow may produce a stable convective environment within the cavity 111, and thus increase diameter control of the optically transmissive material 105 within the cavity 111.

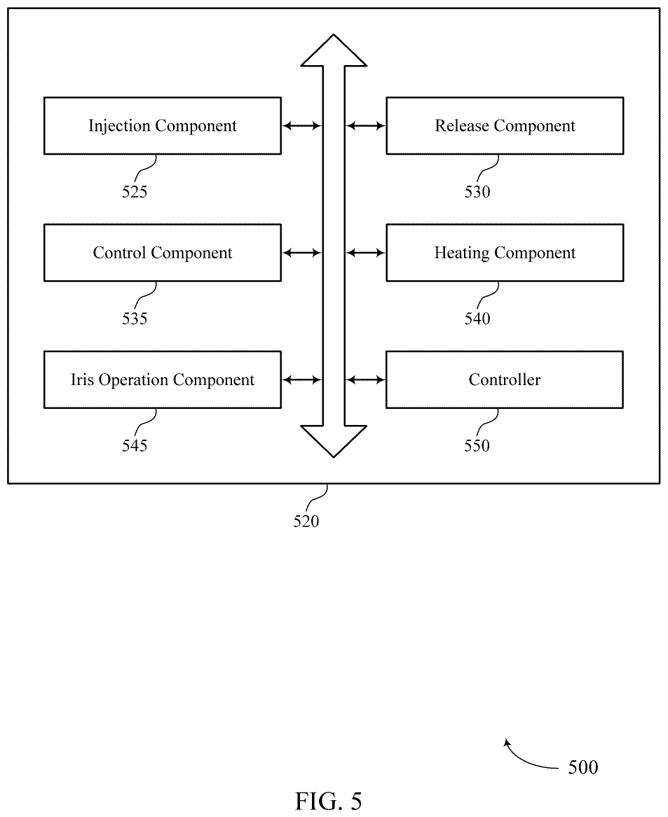

FIG. 5 shows a block diagram 500 of a furnace system 520 that supports counter-directional gas injection for a furnace system in accordance with aspects of the present disclosure. The furnace system 520 may be an example of aspects of furnace system 100 as described with reference to FIG. 1. The furnace system 520, or various components thereof, may be an example of means for performing various aspects of counter-directional gas injection for furnace system 100 as described herein. For example, the furnace system 520 may include an injection component 525, a release component 530, a control component 535, a heating component 540, an iris operation component 545, a controller 550, or any combination thereof. Each of these components may communicate, directly or indirectly, with one another (e.g., via one or more buses).

The injection component 525 may be configured as or otherwise support a means for injecting one or more inert gases into a cavity defined by a muffle, wherein the one or more inert gases are injected via an inlet port positioned at a bottom portion of a lower muffle extension of the muffle, causing the one or more inert gases to flow in a first direction within the cavity, the first direction being opposite of a second direction that is associated with extruding an optical fiber material. The release component 530 may be configured as or otherwise support a means for releasing the one or more inert gases from the cavity via an outlet port positioned at a top portion of an upper muffle extension of the muffle.

In some examples, the injection component 525 may be configured as or otherwise support a means for injecting one or more screen gases into a screen region of the furnace system to prevent one or more external gases from entering an exit port associated with extruding the optical fiber material.

In some examples, the screen region comprises two or more irises (apertures), and the iris operation component 545 may be configured as or otherwise support a means for operating a first iris (first aperture) of the two or more irises to isolate the one or more screen gases in the screen region from the one or more inert gases in the cavity. In some examples, the screen region comprises two or more irises, and the iris operation component 545 may be configured as or otherwise support a means for operating a second iris (second aperture) of the two or more irises to isolate the screen region from the one or more external gases.

In some examples, the control component 535 may be configured as or otherwise support a means for controlling a flow rate of the one or more inert gases injected into the cavity by modulating the flow of the one or more inert gases through a sintered metallic component of an annular plenum ring at the inlet port.

In some examples, the control component 535 may be configured as or otherwise support a means for controlling a flow rate of the one or more inert gases injected into the cavity by modulating the flow of the one or more inert gases through a plurality of circular ports of an annular plenum ring at the inlet port.

In some examples, the control component 535 may be configured as or otherwise support a means for controlling a flow rate of the one or more inert gases released from the cavity based at least in part on a Venturi system coupled with the outlet port, a flow controller coupled with the outlet port, a pump coupled with the outlet port, or any combination thereof.

In some examples, the flow rate of the one or more inert gases is controlled by maintaining a same flow rate of the one or more inert gases injected into the cavity and released from the cavity.

In some examples, the heating component 540 may be configured as or otherwise support a means for heating the cavity via a heater coupled with the muffle.

In some examples, the controller 550 may be coupled with a furnace system, and the controller 550 may be configured or operable to perform one or more techniques that support counter-directional gas injection for the furnace system. For example, the controller 550 may be configured to cause an apparatus to inject one or more inert gases into the cavity, where the one or more inert gases are injected via an inlet port positioned at a bottom portion of a lower muffle extension of the muffle, causing the one or more inert gases to flow in a first direction within the cavity, the first direction being opposite of a second direction that is associated with extruding an optical fiber material. In some examples, the controller 550 may be configured to cause an apparatus to release the one or more inert gases from the cavity via an outlet port positioned at a top portion of an upper muffle extension of the muffle.

In some examples, the controller 550 may be configured to inject one or more screen gases into a screen region of the furnace system to prevent one or more external gases from entering the cavity.

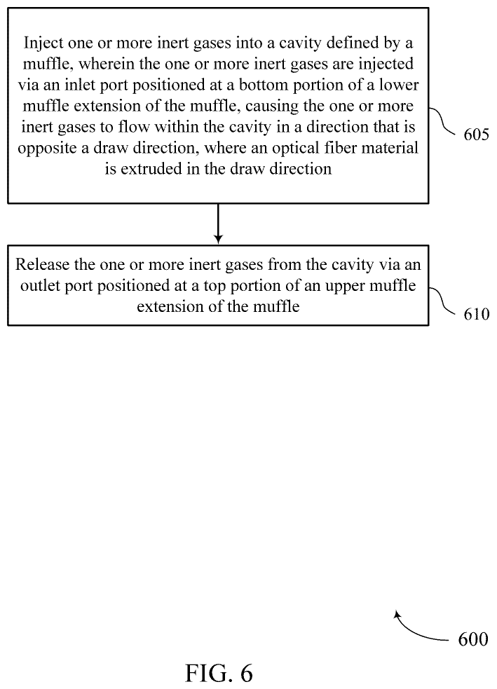

FIG. 6 shows a flowchart illustrating a method 600 that supports counter-directional gas injection for a furnace system in accordance with aspects of the present disclosure. The operations of the method 600 may be implemented by a furnace system or its components as described herein. For example, the operations of the method 600 may be performed by a furnace system as described with reference to FIGS. 1 and 5. In some examples, a furnace system may execute a set of instructions to control the functional elements of the furnace system to perform the described functions. Additionally, or alternatively, the furnace system may perform aspects of the described functions using special-purpose hardware.

At 605, the method may include injecting one or more inert gases into a cavity defined by a muffle, wherein the one or more inert gases are injected via an inlet port positioned at a bottom portion of a lower muffle extension of the muffle, causing the one or more inert gases to flow within the cavity in a direction that is opposite a draw direction, where an optical fiber material is extruded in the draw direction. The operations of 605 may be performed in accordance with examples as disclosed herein. In some examples, aspects of the operations of 605 may be performed by an injection component 525 as described with reference to FIG. 5.

At 610, the method may include releasing the one or more inert gases from the cavity via an outlet port positioned at a top portion of an upper muffle extension of the muffle. The operations of 610 may be performed in accordance with examples as disclosed herein. In some examples, aspects of the operations of 610 may be performed by a release component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor) for injecting one or more inert gases into a cavity defined by a muffle, wherein the one or more inert gases are injected via an inlet port positioned at a bottom portion of a lower muffle extension of the muffle, causing the one or more inert gases to flow within the cavity in a direction that is opposite a draw direction, where an optical fiber material is extruded in the draw direction, and releasing the one or more inert gases from the cavity via an outlet port positioned at a top portion of an upper muffle extension of the muffle.

Some examples of the method 600 and the apparatus described herein may further include operations, features, means, or instructions for injecting one or more screen gases into a screen region of the furnace system to prevent one or more external gases from entering an exit port associated with extruding the optical fiber material.

In some examples of the method 600 and the apparatus described herein, the screen region comprises two or more irises and the method, apparatuses, and non-transitory computer-readable medium may include further operations, features, circuitry, logic, means, or instructions for operating a first iris of the two or more irises to isolate the one or more screen gases in the screen region from the one or more inert gases in the cavity and operating a second iris of the two or more irises to isolate the screen region from the one or more external gases.

Some examples of the method 600 and the apparatus described herein may further include operations, features, means, or instructions for controlling a flow rate of the one or more inert gases injected into the cavity by controlling (e.g., adjusting, modulating, modifying) the flow of the one or more inert gases through a sintered metallic component of an annular plenum ring at the inlet port.

Some examples of the method 600 and the apparatus described herein may further include operations, features, means, or instructions for controlling a flow rate of the one or more inert gases injected into the cavity by controlling the flow of the one or more inert gases through a plurality of circular ports of an annular plenum ring at the inlet port.

Some examples of the method 600 and the apparatus described herein may further include operations, features, means, or instructions for controlling a flow rate of the one or more inert gases released from the cavity based at least in part on a Venturi system coupled with the outlet port, a flow controller coupled with the outlet port, a pump coupled with the outlet port, or any combination thereof.

In some examples of the method 600 and the apparatus described herein, the flow rate of the one or more inert gases may be controlled by maintaining a same flow rate of the one or more inert gases injected into the cavity and released from the cavity.

Some examples of the method 600 and the apparatus described herein may further include operations, features, means, or instructions for heating the cavity via a heater coupled with the muffle.

According to a first aspect of the present disclosure, a method of operating a furnace system is disclosed, the method comprising injecting one or more inert gases into a cavity defined by a muffle, the muffle comprising an upper muffle extension and a lower muffle extension, wherein the one or more inert gases are injected via an inlet port at a bottom portion of the lower muffle extension such that the one or more inert gases flow within the cavity in a first direction. The method further comprising drawing an optical fiber preform within the cavity in a second direction to form an optical fiber, the first direction being opposite to the second direction, and releasing the one or more inert gases from the cavity via an outlet port at a top portion of the upper muffle extension of the muffle.

According to a second aspect of the present disclosure, the first aspect wherein the one or more inert gases flow within the cavity in the first direction from the inlet port to the outlet port.

According to a third aspect of the present disclosure, the first aspect wherein the first direction and the second direction are parallel.

According to a fourth aspect of the present disclosure, the first aspect further comprising injecting one or more screen gases into a screen region of the furnace system to prevent one or more external gases from entering the cavity.

According to a fifth aspect of the present disclosure, the first fourth aspect wherein the screen region comprises an aperture, and the method further comprising opening the aperture when the preform is being drawn within the furnace system and closing the aperture when the preform is not being drawn.

According to sixth aspect of the present disclosure, the fifth aspect wherein the aperture creates a seal when closed.

According to a seventh of the present disclosure, the first aspect wherein the inlet port comprises a porous element, and the method further comprising controlling a flow rate of the one or more inert gases injected into the cavity by controlling the flow of the one or more inert gases through the porous element.

According to an eight aspect of the present disclosure, the first aspect wherein the inlet port comprises a plurality of ports that each comprise a controlled variable opening configured to open and close, and the method further comprising controlling a flow rate of the one or more inert gases injected into the cavity by controlling the flow of the one or more inert gases through the plurality of ports.

According to a ninth aspect of the present disclosure, the first aspect further comprising controlling a flow rate of the one or more inert gases released from the cavity through the outlet port with a Venturi system coupled with the outlet port, a flow controller coupled with the outlet port, a pump coupled with the outlet port, or any combination thereof.

According to a tenth aspect of the present disclosure, the first aspect wherein the flow rate of the one or more inert gases injected into the cavity through the inlet port is substantially the same as the flow rate of the one or more inert gases released from the cavity through the outlet port.

According to an eleventh aspect of the present disclosure, the tenth aspect wherein the flow rate of the one or more inert gases injected into the cavity through the inlet port and the flow rate of the one or more inert gases released from the cavity through the outlet port are both between about 10 and about 20 liters per minute.

According to a twelfth aspect of the present disclosure, the first aspect further comprising heating the cavity via a heater coupled with the muffle.

According to a thirteenth aspect of the present disclosure, a furnace system comprising a muffle that defines a cavity, the cavity being configured to receive an optical fiber preform, an inlet port disposed at a top portion of the muffle and an outlet port disposed at a bottom portion of the muffle, and a heater configured to heat a cavity defined by the muffle. The furnace system further comprising a controller coupled with the furnace system and configured to cause the furnace system to: inject one or more inert gases into the cavity through the inlet port such that the one or more inert gases flow within the cavity in a direction opposite a draw direction of the optical fiber preform and release the one or more inert gases from the cavity via the outlet port.

According to a fourteenth aspect of the present disclosure, the thirteenth aspect wherein the muffle comprises an insulating material at least partially surrounding the cavity.

According to a fifteenth aspect of the present disclosure, the thirteenth aspect further comprising a screen region disposed below the cavity, the screen region comprising a second cavity, and wherein the controller is further configured to cause the furnace system to inject one or more screen gases into the second cavity to prevent one or more external gases from entering the cavity.

According to a sixteenth aspect of the present disclosure, the fifteenth aspect wherein the furnace system comprises a first aperture and a second aperture, the first aperture being configured to isolate the one or more screen gases in the second cavity from the one or more inert gases in the cavity, and the second aperture being configured to isolate the one or more screen gases in the second cavity from the one or more external gases outside of the furnace system.

According to a seventeenth aspect of the present disclosure, the thirteenth aspect wherein the inlet port comprises an annular ring and a porous component configured to control a flow rate of the one or more inert gases injected into the cavity.

According to an eighteenth aspect of the present disclosure, the thirteenth aspect wherein the inlet port comprises an annular ring and a plurality of ports configured to control a flow rate of the one or more inert gases injected into the cavity.

According to a nineteenth aspect of the present disclosure, the thirteenth aspect wherein the outlet port comprises a Venturi system configured to control a flow rate of the one or more inert gases released from the cavity.

According to a twentieth aspect of the present disclosure, the thirteenth aspect wherein the outlet port comprises a pump configured to control a flow rate of the one or more inert gases released from the cavity.

According to twenty-first aspect of the present disclosure, the thirteenth aspect wherein the cavity comprises a consistent internal diameter along the length of the muffle.

According to a twenty-second aspect of the present disclosure, a furnace system comprising a muffle defining a cavity and comprising an insulating material for the cavity, a heater coupled with the muffle and configured to heat the cavity, and a downfeed component positioned within an upper muffle extension of the muffle and configured to support an optical fiber preform when the optical fiber preform is extruded from the cavity in a draw direction. The furnace system further comprising an inlet port positioned at a bottom portion of a lower muffle extension of the muffle and configured to inject one or more inert gases into the cavity in a direction that is opposite the draw direction and an outlet port positioned at a top portion of the upper muffle extension and configured to release the one or more inert gases from the cavity.

According to a twenty-third aspect of the present disclosure, the twenty-second aspect further comprising a screen region positioned below the lower muffle extension and configured to prevent one or more external gases from entering the cavity, wherein the screen region comprises two or more apertures.

According to a twenty-fourth aspect of the present disclosure, the twenty-second aspect further comprising one or more input components coupled with the inlet port, the one or more input components comprising an annular ring and a porous ring or a plurality of circular ports, and one or more exhaust components coupled with the outlet port, the one or more exhaust components comprising a Venturi exhaust, a pump, a mass flow controller, or any combination thereof.

In some examples of the furnace system, the muffle comprises an insulating material at least partially surrounding the cavity and extending into both the lower muffle extension of the muffle and the upper muffle extension of the muffle.

In some examples of the furnace system, the controller may be further configured to cause the apparatus to inject one or more screen gases into a screen region of the furnace system to prevent one or more external gases from entering the cavity.

In some examples of the furnace system, the screen region comprises two or more irises, at least one iris of the two or more irises may be operable to isolate the one or more screen gases in the screen region from the one or more inert gases in the cavity, and another iris of the two or more irises may be operable to isolate the one or more screen gases in the screen region from the one or more external gases outside of the furnace system.

In some examples of the furnace system, the inlet port comprises an annular plenum ring and a sintered metallic component configured to control a flow rate of the one or more inert gases injected into the cavity.

In some examples of the furnace system, the inlet port comprises an annular plenum ring and a plurality of circular ports configured to control a flow rate of the one or more inert gases injected into the cavity.

Some examples of the furnace system may further include a Venturi system coupled with the outlet port that may be configured to control a flow rate of the one or more inert gases released from the cavity.

Some examples of the furnace system may further include a pump coupled with the outlet port that may be configured to control a flow rate of the one or more inert gases released from the cavity.

In some examples of the furnace system, the cavity comprises an approximately consistent internal diameter.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors. Further, any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the article “a” before a noun is open-ended and understood to refer to “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of operating a furnace system, the method comprising:
injecting one or more inert gases into a cavity defined by a muffle, the muffle comprising an upper muffle extension and a lower muffle extension, wherein the one or more inert gases are injected via an inlet port at a bottom portion of the lower muffle extension such that the one or more inert gases flow within the cavity in a first direction;
drawing an optical fiber preform within the cavity in a second direction to form an optical fiber, the first direction being opposite to the second direction; and
releasing the one or more inert gases from the cavity via an outlet port at a top portion of the upper muffle extension of the muffle.

2. The method of claim 1, wherein the one or more inert gases flow within the cavity in the first direction from the inlet port to the outlet port.

3. The method of claim 1, wherein the first direction and the second direction are parallel.

4. The method of claim 1, further comprising:
injecting one or more screen gases into a screen region of the furnace system to prevent one or more external gases from entering the cavity.

5. The method of claim 4, wherein the screen region comprises an aperture, the method further comprising:
opening the aperture when the preform is being drawn within the furnace system and closing the aperture when the preform is not being drawn.

6. The method of claim 5, wherein the aperture creates a seal when closed.

7. The method of claim 1, wherein the inlet port comprises a porous element, the method further comprising:
controlling a flow rate of the one or more inert gases injected into the cavity by controlling the flow of the one or more inert gases through the porous element.

8. The method of claim 1, wherein the inlet port comprises a plurality of ports that each comprise a controlled variable opening configured to open and close, the method further comprising:
controlling a flow rate of the one or more inert gases injected into the cavity by controlling the flow of the one or more inert gases through the plurality of ports.

9. The method of claim 1, further comprising:
controlling a flow rate of the one or more inert gases released from the cavity through the outlet port with a Venturi system coupled with the outlet port, a flow controller coupled with the outlet port, a pump coupled with the outlet port, or any combination thereof.

10. The method of claim 1, wherein the flow rate of the one or more inert gases injected into the cavity through the inlet port is substantially the same as the flow rate of the one or more inert gases released from the cavity through the outlet port.

11. The method of claim 10, wherein the flow rate of the one or more inert gases injected into the cavity through the inlet port and the flow rate of the one or more inert gases released from the cavity through the outlet port are both between about 10 and about 20 liters per minute.

12. The method of claim 1, further comprising:
heating the cavity via a heater coupled with the muffle.

13. A furnace system comprising:
a muffle that defines a cavity, the cavity being configured to receive an optical fiber preform;
an inlet port disposed at a top portion of the muffle and an outlet port disposed at a bottom portion of the muffle;
a heater configured to heat the cavity defined by the muffle; and
a controller coupled with the furnace system and configured to cause the furnace system to:
inject one or more inert gases into the cavity through the inlet port such that the one or more inert gases flow within the cavity in a direction opposite a draw direction of the optical fiber preform, and
release the one or more inert gases from the cavity via the outlet port.

14. The furnace system of claim 13, wherein the muffle comprises an insulating material at least partially surrounding the cavity.

15. The furnace system of claim 13, further comprising a screen region disposed below the cavity, the screen region comprising a second cavity, and wherein the controller is further configured to cause the furnace system to inject one or more screen gases into the second cavity to prevent one or more external gases from entering the cavity.

16. The furnace system of claim 15, wherein the furnace system comprises a first aperture and a second aperture, the first aperture being configured to isolate the one or more screen gases in the second cavity from the one or more inert gases in the cavity, and the second aperture being configured to isolate the one or more screen gases in the second cavity from the one or more external gases outside of the furnace system.

17. The furnace system of claim 13, wherein the inlet port comprises an annular ring and a porous component configured to control a flow rate of the one or more inert gases injected into the cavity.

18. The furnace system of claim 13, wherein the inlet port comprises an annular ring and a plurality of ports configured to control a flow rate of the one or more inert gases injected into the cavity.

19. The furnace system of claim 13, wherein the outlet port comprises
a Venturi system configured to control a flow rate of the one or more inert gases released from the cavity.

20. The furnace system of claim 13, wherein the cavity comprises a consistent internal diameter along the length of the muffle.
